(19) United States
(12) Patent Application Publication
(10) Pub. No.: US 2022/0347883 A1
(43) Pub. Date: Nov. 3, 2022

(54) HONEYCOMB EXTRUSION DIE HAVING SWELL RELIEF

(71) Applicant: CORNING INCORPORATED, CORNING, NY (US)

(72) Inventors: David Jack Bronfenbrenner, Painted Post, NY (US); Michael James Lehman, Canisteo, NY (US)

(21) Appl. No.: 17/774,198

(22) PCT Filed: Nov. 19, 2020
(86) PCT No.: PCT/US2020/061228

§ 371 Date: May 4, 2022

Related U.S. Application Data
(60) Provisional application No. 62/940,462, filed on Nov. 26, 2019.

(51) Int. Cl. B28B 3/26

(52) U.S. Cl. CPC B28B 3/269

(57) ABSTRACT

Improved extrusion dies are described herein for manufacturing a honeycomb body structure (330) from honeycomb extrudate (104). An improved extrusion die (102) comprises a swell relief feature in a discharge slot (218) of the extrusion die (102) that is disposed upstream of a discharge surface (214) of the extrusion die (102). The swell relief feature comprises a change in the width (W) of the discharge slot (218).

### CROSS REFERENCE TO RELATED APPLICATIONS

This application claims the benefit of priority under 35 U.S.C § 120 of U.S. Provisional Application Ser. No. 62/940,462 filed on Nov. 26, 2019, the content of which is relied upon and incorporated herein by reference in its entirety.

### BACKGROUND

Honeycomb bodies are used in a variety of applications, such as particulate filters and catalytic converters that treat pollutants in a combustion exhaust.

The process of manufacturing the honeycomb bodies can include extruding batch material through an extrusion die.

### SUMMARY

Various approaches are described herein for, among other things, providing improved extrusion dies for the manufacture of honeycomb bodies, namely, ceramic honeycomb bodies. For instance, the improved extrusion die includes swell relief features for improving control over the dimensions of a honeycomb extrudate used in the construction of ceramic honeycomb bodies.

In one aspect, a method of manufacturing a honeycomb body is provided. The method comprises extruding a ceramic-forming mixture in an extrusion direction through an intersecting array of discharge slots in a honeycomb extrusion die to form a honeycomb extrudate comprising an intersecting array of walls, the discharge slots being formed by side surfaces of a plurality of pins of the honeycomb extrusion die; wherein the extruding comprises extruding the ceramic-forming mixture through both an upstream slot portion of the discharge slots having a first slot width W1 and a downstream slot portion of the discharge slots having a second slot width W2, wherein the downstream slot portion is adjacent to a discharge surface of the extrusion die and the upstream slot portion is upstream of the downstream slot portion with respect to the extrusion direction; wherein the second slot width W2 is greater than the first slot width W1 but less than an unconstrained swell dimension of the ceramic-forming mixture representative of unconstrained expansion of the ceramic-forming mixture upon exiting the upstream slot portion; wherein the extruding further comprises constraining swell of the ceramic-forming mixture with the downstream slot portion as the ceramic-forming mixture exits the upstream slot portion into the downstream slot portion and limiting a thickness of the walls of the extrudate after the ceramic-forming mixture exits both the upstream and downstream slot portions to less than the unconstrained swell dimension.

In some embodiments, the ceramic-forming mixture does not expand when exiting the downstream slot portion at the discharge surface.

In some embodiments, the side surfaces of the pins side surfaces of the pins are stepped to define the first slot portions having the first width W1 to the second slot portions having the second width W2. In some embodiments, each side surface of each pin comprises a single step at which the discharge slots transition from the first slot portions having the first width W1 to the second slot portions having the second width W2. In some embodiments, each side surface of the pins each comprises a plurality of steps with respect to which the discharge slots transition from the first slot portions having the first width W1 to the second slot portions having the second width W2.

In some embodiments, the side surfaces of the pins are tapered to transition the discharge slot from the first slot portions having the first width W1 to the second slot portions having the second width W2.

In some embodiments, the side surfaces of the pins defining walls of the downstream slot portions are parallel with respect to the extrusion direction.

In some embodiments, each pin has a length of less than 1.00 inch.

In some embodiments, the second width W2 is equal to or less than 0.005 inch (0.13 mm).

In some embodiments, a percentage difference between the first width W1 and the second width W2 relative to the second width W2 is in a range between 1% and 10%.

In some embodiments, the extruding is performed for every discharge slot in the extrusion die.

In another aspect, a method of forming a honeycomb extrudate is provided. The method comprises extruding a ceramic-forming mixture in an extrusion direction through an intersecting array of discharge slots in a honeycomb extrusion die, each discharge slot comprising both an upstream slot portion having a first slot width W1 and a downstream slot portion of the discharge slots having a second slot width W2; wherein the downstream slot portion is adjacent to a discharge surface of the extrusion die and the upstream slot portion is upstream of the downstream slot portion with respect to the extrusion direction; wherein the second slot width W2 is greater than the first slot width W1; and wherein the extruding further comprises permitting swelling of the ceramic-forming mixture as the ceramic-forming mixture exits the upstream slot portion into the downstream slot portion but the ceramic precursor does not swell as the ceramic-forming mixture exits the downstream slot portion at the discharge surface.

In some embodiments, the second slot width W2 is less than an unconstrained swell dimension of the ceramic-forming mixture representative of unconstrained expansion of the ceramic-forming mixture upon exiting the upstream slot portion.

In another aspect, a honeycomb extrusion die for extruding a batch mixture is provided. The honeycomb extrusion die comprises a die body, comprising: an inlet surface and a discharge surface opposite the inlet surface; feedholes extending from the inlet surface into the die body; and a plurality of pins, each pin extending from a pin root to an end surface that at least partially defines the discharge surface; wherein side surfaces of the plurality of pins define an intersecting array of discharge slots extending from the discharge surface into communication with the feedholes within the die body, and the discharge slots comprise a first slot portion having a first width W1 and a second slot portion having a second width W2, the second slot portion being located adjacent to the discharge surface and the first slot portion being located between the second slot portion and the pin root, and wherein the second slot width W2 is greater than the first slot width W1 but less than an unconstrained swell dimension of the ceramic-forming mixture representative of unconstrained expansion of the ceramic-forming mixture upon exiting the first slot portion, such that the second slot portion constrains swell of the batch material as the batch material exits the first slot portion into the second slot portion and sets a total swell of the batch mixture through both the first and second portions to be less than the unconstrained degree of swell.

In some embodiments, the side surfaces of the pins side surfaces of the pins are stepped to define the first slot portions having the first width W1 to the second slot portions having the second width W2.

In some embodiments, each side surface of each pin comprises a single step at which the discharge slots transition from the first slot portions having the first width W1 to the second slot portions having the second width W2.

In some embodiments, each side surface of the pins each comprises a plurality of steps with respect to which the discharge slots transition from the first slot portions having the first width W1 to the second slot portions having the second width W2.

In some embodiments, the side surfaces of the pins are tapered to transition the discharge slot from the first slot portions having the first width W1 to the second slot portions having the second width W2.

In some embodiments, the pins have a length of less than 1.00 inch.

In some embodiments, the second width W2 is less than 0.005 inch.

In some embodiments, a percentage difference between the first width W1 and the second width W2 relative to the second width W2 is in a range between 1% and 10%.

In some embodiments, the plurality of intersecting discharge slots comprises every discharge slot in the extrusion die.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a perspective view of a system comprising an extruder and a honeycomb extrudate according to one embodiment disclosed herein.

FIG. 2 is a perspective view of a portion of a comparative extrusion die.

FIG. 3 is a side view of a portion the comparative extrusion die of FIG. 2.

FIG. 4 is a perspective view of a honeycomb body that can be manufactured via the methods and extrusion dies disclosed herein.

FIG. 5 is an end view of the honeycomb body shown in FIG. 4.

FIGS. 6-11 are a side views of relevant portions of extrusion dies in accordance with various embodiment disclosed herein that can be used with the extruder of FIG. 1.

FIG. 12 depicts a flowchart of a method of manufacturing an extrusion die in accordance with some embodiments disclosed herein.

FIG. 13 depicts a flowchart of a method of manufacturing a honeycomb body in accordance with some embodiments disclosed herein.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings that illustrate example embodiments of the present invention. The scope of the present invention is not limited to the illustrated embodiments.

References in the specification to “one embodiment,” “an embodiment,” “an example embodiment,” or the like, indicate that the embodiment described includes a particular feature, structure, or characteristic, but other embodiments do not necessarily include the particular feature, structure, or characteristic.

The example embodiments generally provide improved extrusion dies for producing thin inner walls in a honeycomb body. As the thickness of the inner walls is reduced, the extruded mixture becomes more susceptible to swelling. The extruded mixture may be referred to herein interchangeably as a ceramic-forming mixture, ceramic-precursor mixture, or batch mixture. Such ceramic-forming mixtures (and/or ceramic-precursor mixtures and/or batch mixtures) can comprise components such as ceramic materials (e.g., cordierite particles, aluminum titanate particles, etc.) and/or ceramic-precursor materials (e.g., clay, talc, etc.), that upon firing will react and/or sinter to form a ceramic body.

A swell relief feature, such as a widening of the discharge slots of a honeycomb extrusion die, is configured so that material swell takes place prior to the ceramic-forming mixture exiting the extrusion die. Including the swell relief feature upstream of the discharge face of the extrusion die enables greater control of the thickness of the walls of the extrudate. As a result, the swell relief feature improves the uniformity of the wall thickness of the honeycomb body and/or conformity of the wall thickness(es) of the honeycomb body to one or target dimensions. The swell relief feature also permits the extrusion of thinner walls in a honeycomb body for a given ceramic-forming mixture. The swell relief feature construction also enables honeycomb extrusion dies to be constructed having narrow slot portions, thereby in some instances leading to an increase in the thickness and thus strength of the pin root in the extrusion die for a given extruded wall thickness.

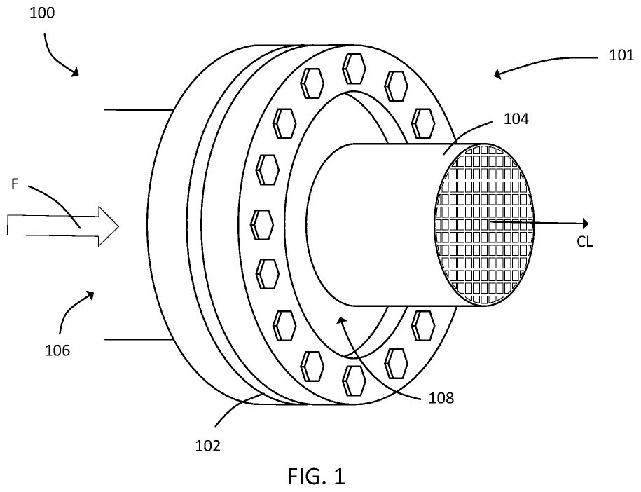

Referring to FIG. 1, an extrusion system 100 comprises an extruder 101, comprising an extrusion die 102, and a honeycomb extrudate 104 that can be formed by extruding a ceramic-forming mixture through the extrusion die 102. The extruder 101 comprises an inlet 106 and an outlet 108 and forces a flow F of ceramic-forming mixture to travel in the extrusion direction from the inlet 106 to the outlet 108. The extrusion die 102 is interposed between the inlet 106 and the outlet 108 and shapes the ceramic-forming mixture into the honeycomb extrudate 104 as the ceramic-forming mixture exits the extruder 101. The honeycomb extrudate 104 can be severed at a desired length after exiting the extrusion die 102 to form a green honeycomb body. In examples, the extruder 101 can be configured to mix components of the ceramic-forming mixture and/or to drive the ceramic-forming mixture using a screw mechanism or a ram mechanism.

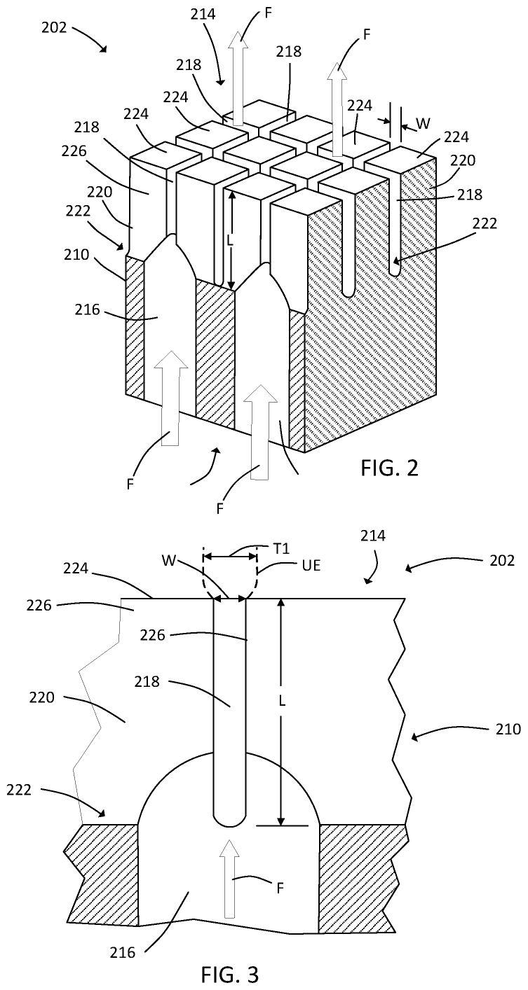

Referring to FIGS. 2-3, an extrusion die 202 comprises a die body 210 that has an inlet surface 212 and a discharge surface 214. The die body 210 defines a flow path for the ceramic-forming mixture. The flow path is defined by a plurality of feedholes 216 at the inlet surface 212 and a plurality of discharge slots 218 at the discharge surface 214. The feedholes 216 are in fluid communication with a source of the ceramic-forming mixture at a side of the extrusion die 202 that is closest to the inlet 106. The feedholes 216 are also in fluid communication with the discharge slots 218 at intersections or connections within the die body 210. The discharge slots 218 are defined by side surfaces of a plurality of pins 220 that are disposed on a side of the extrusion die 202 that is closest to the outlet 108. The flow F of ceramic-forming mixture enters the extrusion die 202 through the plurality of feedholes 216 and is distributed into the discharge slots 218. The size and shape of the discharge slots 218 are configured to provide a predefined thickness of inner walls of the honeycomb extrudate 104.

Each pin 220 comprises a root 222, a tip 224, and side surfaces 226 that extend between the root 222 and the tip 224. The root 222 forms a base of the pin 220 at a feedhole/discharge slot interface, i.e., at the location where feedholes 216 and discharge slots 218 connect in fluid communication and therefore the ceramic-forming mixture flow path transitions from the feedhole 216 to one or more discharge slots 218. The discharge slots 218 can comprise features to assist in extrusion, such as plenums and/or divots. The tips 224 of the pins of the extrusion die 202 form the discharge surface 214 of the extrusion die. The pins 220 comprise are spaced from each other by a width W that defines, and may be referred to as, the slot width for the discharge slots 218. The slots 218 extend a length L into the die body 210 between the surfaces 226 of the pins. Since the slots 218 are defined with respect to the pins 220, the length L can also be considered as the axial length of the pins 220.

As described herein, during a honeycomb extrusion process, a ceramic-forming mixture may experience swell (dimensional expansion) as the ceramic exits the discharge slots 218 of the extrusion die 202. For example, as the ceramic-forming mixture flows from a bulk slug in an extruder (e.g., if the extrusion die 202 is used as the extrusion die 102 in the extruder 101 in FIG. 1) to the relatively narrower discharge slots 218 (e.g., through the restricted flow area provided by the feedholes 216, and then into the even further restricted flow area provided by the discharge slots 218), the stress in the mixture (e.g., the stress normal to the side surfaces 226 of the pins 220), progressively increases. In this scenario, upon exiting the die 202 at the discharge surface 214, the ceramic-forming mixture will relieve this stress by swelling, thus making the walls of the extrudate thicker than the width W of the discharge slots. For example, an extrudate, referred to herein as an unconstrained extrudate UE, is schematically illustrated in FIG. 3 having a thickness T1 after swelling that is larger than the slot width W of the discharge slots 218.

The amount of swell of a ceramic-forming mixture may be at least partially defined by an elastic modulus of the ceramic-forming mixture. Additionally, the degree of swell may be at least partially defined by the slot width of the discharge slots through which the ceramic-forming mixture is extruded. For example, narrower slots may cause the ceramic-forming mixture to be more highly compressed, which results in higher stresses and a proportionally greater swell response when the ceramic-forming mixture exits the discharge slots at the discharge surface, while relatively wider slots may produce a lower amount of stress and thus swelling for a given ceramic-forming mixture. Relative to the slot width of the discharge slots at the discharge surface, the percent that the ceramic-forming mixture swells (that is, the percent difference between the slot width and the expanded extrudate thickness) may increase as the slot width is narrowed. In other words, the percentage that the extrudate walls expand due to swelling increases as the width of the discharge slots is reduced.

The amount of swell may also be at least partially influenced by the length of the slots, e.g., length L. For example, longer slot lengths may assist in stabilizing the ceramic-forming mixture. However, long slot lengths are difficult to manufacture, and may lead to increased die impedance (thus requiring higher extrusion pressures for a given mixture), and/or weaker pin strength, and thus, less durable extrusion dies. In particular, undesirably large degrees of swell may result when the slot width W of the discharge slot is particularly thin, e.g., less than or equal to about 0.006″ (0.15 mm) and/or the length L is particularly short, e.g., less than about 1.00″ (25.4 mm).

In contrast to the slots 218, at least some of the discharge slots in the embodiments disclosed herein comprise a swell relief feature that enables enhanced control of the swell of the ceramic-forming material through the extrusion die 102, and thereby enhanced control of the thickness(es) of the walls extruded honeycomb body 104.

The side surfaces 226 can be shaped so that the discharge slots 218 have the same size and shape throughout the extrusion die 102 (i.e., so that every discharge slot of the extrusion die 102 has the same size and shape), or so that the discharge slots 218 have different sizes and/or shapes in different regions of the extrusion die 102 (i.e., so that every discharge slot of the extrusion die 102 in a designated region has the same size and shape). In some embodiments, the discharge slots 218 have a width W at the discharge surface 214 that is less than 0.030″ (0.76 mm). In some embodiments, the width W of the discharge slots 218 is less than 0.010″ (0.25 mm). In an example embodiment the width W of the discharge slots 218 is about 0.006″ (0.15 mm).

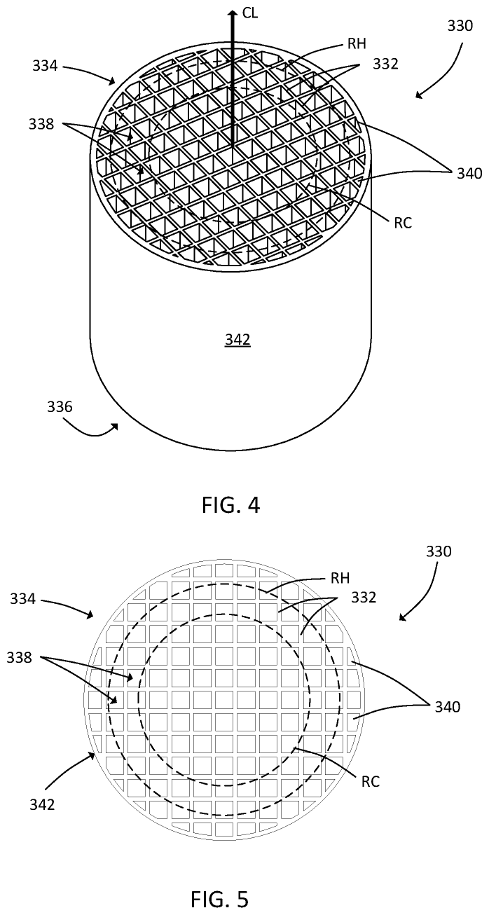

FIGS. 4 and 5 illustrate an exemplary honeycomb body 330 that is manufactured using extruder 101 and severed from the honeycomb extrudate 104. The honeycomb body 330 comprises a plurality of spaced and intersecting inner walls 332, or webs, extending longitudinally through the honeycomb body 330 from a first end face 334, i.e., an inlet surface for a working fluid (e.g., exhaust gases from an internal combustion engine to be treated), to a second end face 336, i.e., a discharge surface for the working fluid. The inner walls 332 combine to define a plurality of channels 338, or cells, that form the cellular honeycomb construction of the honeycomb body 330. The honeycomb body 330 also comprises peripheral channels 340 that are generally partial channels that intersect an outer skin 342 of the honeycomb body 330. As illustrated, the honeycomb body 330 comprises channels 338 having a square cross-sectional shape, but the channels 338 can have other cross-sectional shapes, such as triangular, hexagonal, or combinations of shapes, etc. The size and shape of the channels 338 correspond to the shape and size of the pins included in the extrusion die 102 used to manufacture the honeycomb body 104. The honeycomb body 330 has a central longitudinal axis CL that extends between the first end face 334 and the second end face 336 and that is substantially parallel to a longitudinal axis of the channels 338. The central longitudinal axis CL extends through the extrusion die and corresponds to the direction of extrusion of the ceramic-forming mixture through the extrusion die during the manufacturing process.

The honeycomb body 330 after being initially cut from the extrudate 104 may be referred to as a green honeycomb body. After firing, the ceramic-forming material in the green state of the honeycomb body 330 reacts and/or sinters to convert the honeycomb body 330 to a ceramic state. Accordingly, after extruding the ceramic-forming mixture through an extrusion die to form a green body, the green body can be dried, cut, and fired to form a ceramic material. The honeycomb body 330 can be constructed from a porous ceramic material. If the honeycomb body 330 is intended for use as a particular filter, alternating ones of the channels 318 can be plugged at opposite ends 334, 336.

In some embodiments, the thickness of the inner walls 332 is consistent throughout the honeycomb body 330. However, it may be desirable in other embodiments to have different wall thicknesses at different sections or areas of the honeycomb body 330. Thus, the thickness of the inner walls 332 can vary corresponding to regions of the honeycomb body structure 330. Relatedly, each of the regions of different wall thickness of the honeycomb body 330 can corresponds to a region of the extrusion die configured to extrude the corresponding walls with the target thickness. For example, concentric regions of the honeycomb body 330 are defined relative to the central longitudinal axis CL of the honeycomb body 330 in FIGS. 4-5. The thickness of the inner walls can be different in each of those regions with corresponding regions of the extrusion die 102 having different configurations (e.g., slot widths) to efficiently produce the selected wall thicknesses. In an example embodiment, a honeycomb body 330 comprises a halo region that corresponds to an annular peripheral portion of the honeycomb body 330 (and a corresponding portion of the extrusion die), disposed outward of dashed line RH. The halo region can comprise the outermost cells being constructed with inner walls 332 having greater thickness than other regions in the honeycomb body 330. In an example embodiment, the diameter of the line RH is less than or equal to 20% of the largest outer dimension of the honeycomb body 330. The honeycomb body 330 also comprises a core region that corresponds to a central portion of the honeycomb body 330 disposed inward of dashed line RC that encompasses the central longitudinal axis CL. In some embodiments, the lines RC and RH can be essentially combined into a single line, such that the honeycomb body 330 has two regions with different wall thicknesses, i.e., the regions radially inward and radially outward of this line.

As the width W of the discharge slots 218 at the discharge surface 214 decreases and/or the length L of the pin decreases, the extruded ceramic-forming mixture exhibits more swell upon exiting the die 202, such that the extrudate thickness is greater than the width W of the discharge slot 218. A swell relief feature can be incorporated into discharge slots according to extrusion dies disclosed herein to control the swell, and to increase the predictability and/or improve the uniformity of the final dimensions of the honeycomb extrudate 104, e.g., the thickness of the inner walls 332.

The extrusion dies disclosed herein to produce the honeycomb body 330 can be configured to include swell relief features in all of the discharge slots of the die, in a majority of the discharge slots of the die, or in predefined regions of the die. Additionally, various constructions and/or combinations of swell relief features can be included in a single extrusion die. In some embodiments, the die comprises swell relief features in at least a core region of the die, e.g., radially inwardly of the line RC in FIGS. 4-5.

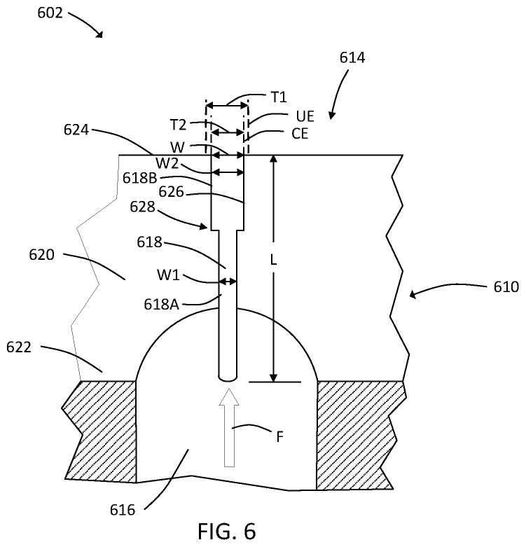

Referring to FIGS. 6-11, various embodiments of extrusion dies are illustrated in which each extrusion die comprises a discharge slot having a swell relief feature in the form of an increase in the slot width at a downstream portion of the slot. With the exception of swell relief features, the components of the extrusion dies in FIGS. 6-11 (e.g., pins, slots, etc.) otherwise generally resemble those described above with respect to extrusion die 202. In example embodiments, the swell relief feature may be particularly advantageous when the width W of the discharge slot at a discharge surface is narrow, e.g., equal to or less than about 0.006″ (0.15 mm) and/or the length L is short, e.g., less than about 1.00″ (25.4 mm). In some embodiments, the slot width W at the discharge surface is less than or equal to about 0.005″ (0.13 mm). By including the swell relief feature upstream of the discharge surface, the thickness of the walls of the extrudate after exiting the discharge surface exhibits less swell, and thereby more closely complies with the width W of the discharge slot at the discharge surface. As described in more detail below, the swell behavior, e.g., as a result of relieving stress in the ceramic-forming mixture, takes place prior to the ceramic-forming mixture exiting the die so that the wall thickness of the extrudate more closely matches the slot width W. In extrusion dies lacking such swell relief features as described herein, the resulting swell of the ceramic-forming mixture may cause the die to not consistently produce the target wall thickness.

FIG. 6 shows an extrusion die 602 that comprises a die body 610 that comprises a discharge surface 614. The die body 610 defines the flow path for the ceramic-forming mixture. The flow path is defined by a plurality of feedholes 616 (at an inlet surface, not shown, of the extrusion die 602 opposite to the discharge surface 614) and a plurality of discharge slots 618 at the discharge surface 614. The discharge slots 618 are defined by side surfaces of a plurality of pins 620. The flow F of the ceramic-forming mixture enters the extrusion die 602 through the plurality of feedholes 616 and is distributed into the discharge slots 618.

Each pin 620 comprises a root 622, a tip 624, and side surfaces 626 that extend between the root 622 and the tip 624. In the illustrated embodiment, the side surfaces 626 of the pins 620 are stepped such that the discharge slots 618 comprise a first, or upstream, slot portion 618A having a first slot width W1, and a second, or downstream, slot portion 618B having a second slot width W2. That is, the pins 620 comprise a step 628 at which the discharge slot transitions between the first slot portion 618A and the second slot portion 618B. Machining techniques such as using wire EDM or abrasive wheel grinding can be used to widen a downstream portion of an existing discharge slot to form the step 628.

In some embodiments, a percentage difference between the second width W2 and the first width W1 relative to W2 is in a range between 1% and 10%. In an example embodiment, the second width W2 is about 0.005″ (0.13 mm) and the first width W1 is about 0.0045″ (0.11 mm) corresponding to a 10% difference between the first width W1 and the second width W2 relative to width W2.

In the illustrated embodiment, the discharge slot 618 has the width W at the discharge surface 614 that is substantially equal to the desired thickness of the extruded wall of the honeycomb extrudate. By enlarging the slot width W2 of the downstream slot portion 618B relative to the slot width W1 of the upstream slot portion 618A, the ceramic-forming mixture is permitted to expand, and thus relieve stresses imparted on the ceramic-forming mixture during extrusion, while the ceramic-forming material is still inside the extrusion die 602. The second slot width W2 is set so that it is greater than the first slot width W1 but so that it limits the degree of swell that is permitted by the ceramic forming material as the ceramic-forming material exits the upstream slot portion 618A into the downstream slot portion 618B. That is, the slot width W2 is selected so that it constrains the degree of swell of the ceramic-forming mixture as the ceramic-forming mixture exits the upstream portion 618A.

Thus, even though some degree of swell is permitted upon entering the downstream slot portion 618B, the downstream slot portion 618B acts to constrain swell of the material. For example, the thickness T1, representative of the unconstrained swell of the extrudate as described with respect to FIG. 3, is superimposed on FIG. 6. In other words, the thickness T1 is representative of the dimension (“unconstrained swell dimension”) of the extrudate that would have resulted if the extrudate were permitted to undergo unconstrained expansion upon exiting the upstream slot portion.

By permitting some degree of swell as the ceramic-forming material exits from the upstream slot portion 618A to the downstream slot portion 618B, but then constraining the swell with the downstream portion 618B, a thickness T2 (“constrained swell thickness”) of the extrudate, identified in FIG. 6 as a constrained extrudate CE, is advantageously achieved. Unexpectedly, the constrained thickness T2 exiting the relatively wider slot width W2 can in this way be achieved as thinner than the unconstrained thickness T1 that would have resulted if the ceramic-forming mixture were permitted to unconstrainedly swell after exiting the relatively thinner upstream portion 618A. Furthermore, while the thickness T2 is consistently achievable by the slot 618 having both widths W1 and W2, a die having a constant slot width of either width W1 or W2 may not be able to produce wall thicknesses as narrow as constrained swell thickness T2.

It is noted that in some embodiments, some degree of swell may still occur, e.g., thickness T2 may be larger than the slot width W2. However, even if there is some swell, the thickness T2 can still be less than the unconstrained swell thickness T1. Additionally, even if there is some degree of swell, due to permitting and then constraining swell within the extrusion die by the downstream slot portion immediately prior to discharge from the discharge surface, the consistency, uniformity, and/or predictability of the wall thicknesses of the extrudate 104 can be improved. Without wishing to be bound by theory, it is believed that constraining the swell of the ceramic-forming material with the downstream slot portion 618B shortly after permitting the ceramic-forming material to swell may act to stabilize the ceramic-forming material after the stress is relieved upon exiting the upstream portion 618A. While this may introduce some stress back into the ceramic-forming material, the degree of stress is not high, and the addition of stress may prove advantageous at this late stage in the extrusion process. For example, the constraining can assist in re-aligning, orienting, and/or packing the particles of the ceramic-forming mixture just prior to exiting the discharge surface. Accordingly, the stabilization provided by constraining swell with the downstream slot portion may be useful to improve consistency, predictability, and/or uniformity in the wall thickness of extrudates, particularly in comparison to extrudate that only undergoes unconstrained swell. To further assist in stabilization, it is preferred in some embodiments to form the downstream slot portion (e.g., the downstream slot portion 618B) with substantially straight walls (e.g., side surfaces 626) that are parallel with respect to the extrusion direction. That is, the use of straight, parallel walls for the downstream slot portion immediately upstream and adjacent to the discharge surface can be particularly beneficial in some embodiments to facilitate in the manufacture of straight, consistently dimensioned walls.

Additionally, as a result of the inventive swell relief feature, the upstream portion (e.g., portion 618A) of the discharge slot can have a width that is narrower than achievable in known extrusion dies, which results in the root (e.g., pin root 622) of each pin (e.g., pins 620) being thicker, and thereby having greater strength than thinner pins in extrusion dies having wider slots.

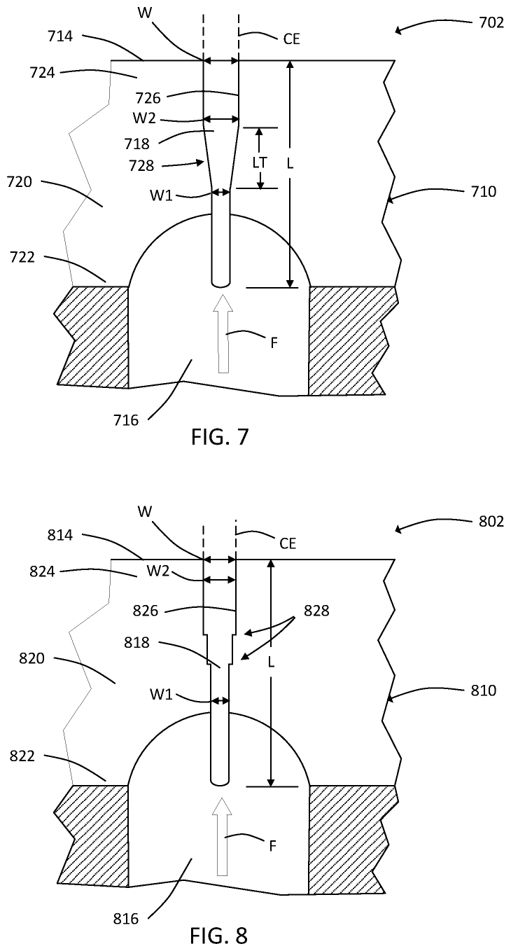

FIGS. 7-11 describe additional embodiments comprising swell relief features that function akin to that described with respect to FIG. 6. Namely, these embodiments each comprise a discharge slot comprising an upstream (first) slot portion having a first slot width W1 and a downstream (second) slot portion having a second slot width W2 that is greater than the width W1. The downstream slot portion is located adjacent to the discharge surface of the extrusion die, and the upstream slot portion is located between the second slot portion and the root of the pin defining the discharge slot. The second slot width W2 is greater than the first slot width W1, but less than an unconstrained swell dimension T1 of the ceramic-forming mixture, which unconstrained swell dimension T1 is representative of unconstrained expansion of the ceramic-forming mixture upon exiting the upstream slot portion. In this way, the downstream slot portion constrains swell of the ceramic-forming material as the ceramic-forming material exits the upstream slot portion into the downstream slot portion. In this way, a total swell of the ceramic-forming mixture through both the upstream and downstream portions is limited to an amount less than the unconstrained degree of swell represented by the unconstrained swell dimension T1.

Referring to FIG. 7, an extrusion die 702 comprises a discharge slot having a swell relief feature in the form of a tapered section 728 (as opposed to the stepped pins in extrusion die 602). Extrusion die 702 comprises a die body 710 that comprises an inlet surface and a discharge surface 714. The die body 710 defines a flow path for the ceramic-forming mixture that comprises a plurality of feedholes 716 and a plurality of discharge slots 718. The discharge slots 718 are defined by gaps between a plurality of pins 720. The flow F of ceramic-forming mixture enters the extrusion die 702 through the plurality of feedholes 716 and is distributed into the discharge slots 718. Each pin 720 comprises a root 722, a tip 724, and side surfaces 726 that extend between the root 722 and the tip 724.

The tapered section 728 is spaced upstream from the discharge surface 714 and has a length LT corresponding to a percentage of the length L of the discharge slot 718 that is in a range between 25% and 75%. The width of the tapered section 728 changes gradually from a first width W1 to a second width W2. In an example embodiment, the second width W2 is about 0.005″ (0.13 mm) and the first width W1 is about 0.0045″ (0.11 mm) corresponding to a 10% difference between the first width W1 and the second width W2 relative to width W2.

Even when the swell relief feature is formed as a taper, e.g., the tapered section 728, the side surfaces 726 defining the downstream slot portion of the discharge slots 718 downstream of the tapered section 728 can be substantially straight and arranged parallel to the extrusion direction (the extrusion direction indicated by the flow arrows F). As described above, the inclusion of substantially straight, parallel walls for the downstream portion of the discharge slot can assist in stabilizing the ceramic-forming mixture after it is permitted to relief stress upon exiting the upstream portion, thereby resulting in reduced or even no swell when the ceramic-forming material exits the extrusion die at the discharge surface.

Referring to FIG. 8, another embodiment of an extrusion die 802 comprises a discharge slot having a swell relief feature in the form of a plurality of steps. Extrusion die 802 comprises a die body 810 that comprises an inlet surface and a discharge surface 814. The die body 810 defines a flow path for the ceramic-forming mixture that comprises a plurality of feedholes 816 and a plurality of discharge slots 818. The discharge slots 818 are defined by gaps between a plurality of pins 820. The flow F of ceramic-forming mixture enters the extrusion die 802 through the plurality of feedholes 816 and is distributed into the discharge slots 818. Each pin 820 comprises a root 822, a tip 824, and side surfaces 826 that extend between the root 822 and the tip 824. The plurality of steps 828 alter the width of the discharge slot stepwise from a first width W1 to a second width W2. In an example embodiment, the second width W2 is about 0.005″ (0.13 mm) and the first width W1 is about 0.0045″ (0.11 mm) corresponding to a 10% difference between the first width W1 and the second width W2 relative to width W2.

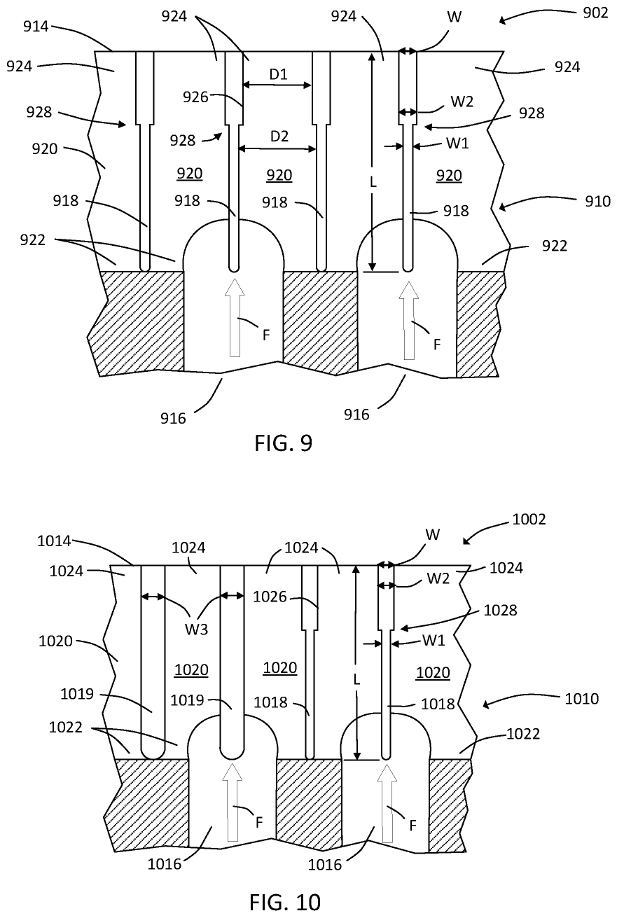

Referring to FIG. 9, a portion of an extrusion die 902 is illustrated in which a swell relief features is included in every discharge slot in the extrusion die 902. Extrusion die 902 comprises a die body 910 that comprises an inlet surface (not shown) and a discharge surface 914. The die body 910 defines a flow path for the ceramic-forming mixture that comprises a plurality of feedholes 916 and a plurality of discharge slots 918. The discharge slots 918 are defined by gaps between a plurality of pins 920. The flow F of ceramic-forming mixture enters the extrusion die 902 through the plurality of feedholes 916 and is distributed into the discharge slots 918. Each pin 920 comprises a root 922, a tip 924, and side surfaces 926 that extend between the root 922 and the tip 924.

Each of the discharge slots 918 is constructed to include a swell relief feature that is upstream from the discharge surface 914. The swell relief feature is shown as a step 928 between a first (upstream) portion of the discharge slot 918 having a first width W1 and a second (downstream) portion of the discharge slot 918 having a second width W2. The embodiment of FIG. 9 illustrates that all of the discharge slots 918 comprise a swell relief feature. Although discharge slots 918 are illustrated with swell relief features constructed as a step, the swell relief features can have other constructions such as tapered or multi-step constructions as described herein. In some embodiments, instead of every discharge slot in an extrusion die having such a swell relief feature, at least a majority of the discharge slots (i.e., at least 50% of the discharge slots with respect to the total area of the discharge slots at the discharge face) are equipped with a swell relief feature.

Additionally, the swell relief feature can be described in relation to the dimensions of the pins 920. For example, each of the illustrated pins 920 has a first outer dimension D1 between opposite side surfaces 926 at a location adjacent the discharge surface 914. Each of the illustrated pins 920 also has a second outer dimension D2 between opposite side surfaces 926 at a location spaced toward the pin root 922 from the discharge surface 914. The first outer dimension D1 is less than the second outer dimension D2 and the difference in the outer dimensions is configured to form the step 928.

Referring to FIG. 10, a portion of an extrusion die 1002 comprising discharge slots having multiple different configurations in a single extrusion die is illustrated. Extrusion die 1002 comprises a die body 1010 that comprises an inlet surface and a discharge surface 1014. The die body 1010 defines a flow path for the ceramic-forming mixture that comprises a plurality of feedholes 1016 and a plurality of discharge slots 1018, 1019. The discharge slots 1018, 1019 are defined by gaps between a plurality of pins 1020 and have different configurations throughout the extrusion die 1002. The flow F of ceramic-forming mixture enters the extrusion die 1002 through the plurality of feedholes 1016 and is distributed into the discharge slots 1018, 1019. Each pin 1020 comprises a root 1022, a tip 1024, and side surfaces 1026 that extend between the root 1022 and the tip 1024.

The discharge slots 1018, 1019 have different configurations and can be distributed in different regions of the extrusion die 1002. For example, discharge slots 1018 form a first plurality of discharge slots that can comprise a swell relief feature, such as one or more steps or a tapered section, that is disposed upstream of the discharge surface 1014. Similar to previously described embodiments, each of the discharge slots 1018 can comprise a step 1028 that is defined by an upstream portion of the discharge slot 1018 having a a first width W1, and a second, downstream portion of the discharge slot 1018 having a second width W2 that is greater than width W1. As illustrated, discharge slots 1019 form a second plurality of discharge slots that have substantially constant width W3.

In an example embodiment, the discharge slots 1019 having the constant discharge slot width W3 are disposed toward a peripheral region of the die body from the discharge slots 1018, which comprise the swell relief features. As a result, the discharge slots 1018 are disposed in a core region, e.g., more centrally located, within the extrusion die 1002 than the discharge slots 1019. An extrudate manufactured using the extrusion die 1002 may in this manner comprise walls with thicknesses that are greater toward the peripheral region of the honeycomb extrudate (due to the unconstrained swell through the slots 1019 having the constant slot width W3) than the thicknesses of more centrally located walls that are permitted to swell within the die and then constrained by the downstream portions of the discharge slots 1018.

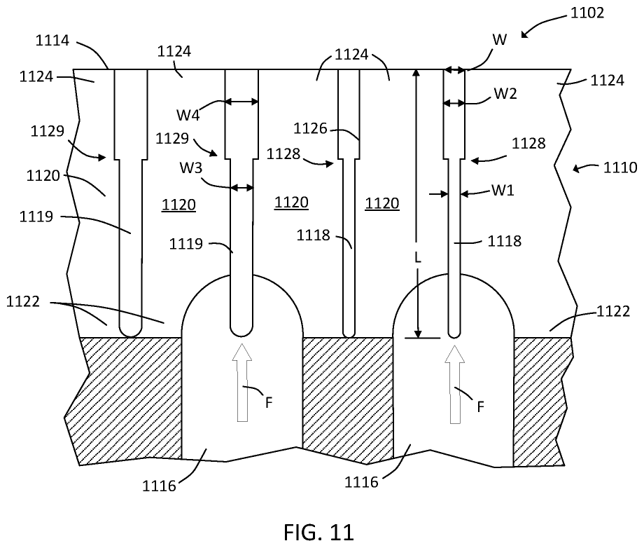

Referring to FIG. 11, another example of a portion of an extrusion die 1102 comprising discharge slots having different configurations is illustrated. Extrusion die 1102 comprises a die body 1110 that comprises an inlet surface and a discharge surface 1114. The die body 1110 defines a flow path for the ceramic-forming mixture that comprises a plurality of feedholes 1116 and a plurality of discharge slots 1118, 1119. The discharge slots 1118, 1119 are defined by gaps between a plurality of pins 1120 and have different configurations throughout the extrusion die 1102. The flow F of ceramic-forming mixture enters the extrusion die 1102 through the plurality of feedholes 1116 and is distributed into the discharge slots 1118, 1119. Each pin 1120 comprises a root 1122, a tip 1124, and side surfaces 1126 that extend between the root 1122 and the tip 1124.

The discharge slots 1118, 1119 have different configurations and can be distributed in different regions of the extrusion die 1102. For example, discharge slots 1118 form a first plurality of discharge slots that can comprise a swell relief feature, such as one or more steps or a tapered section, that is disposed upstream of the discharge surface 1114. Similar to previously described embodiments, each of the discharge slots 1118 can comprise a step 1128 that is defined by a first (upstream) portion of the discharge slot 1118 having a first width W1, and a second (downstream) portion of the discharge slot 1118 having a second width W2 that is greater than width W1. As illustrated, each of discharge slots 1119 comprises a step 1029 that is defined by a first (upstream) portion of the discharge slot 1119 having a third width W3, and a second portion of the discharge slot 1119 having a fourth width W4 that is greater than width W3, where the slot widths W3 and W4 are not the same as the slot widths W1 and W2.

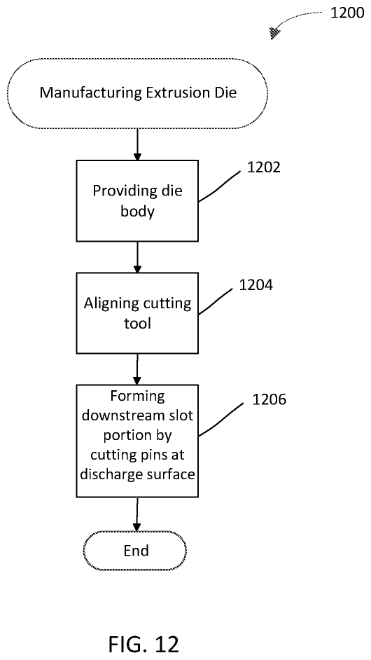

FIG. 12 depicts a flowchart 1200 for manufacturing an extrusion die. Flowchart 1200 can be performed to manufacture an extrusion die such as extrusion dies 602, 702, 802, 902, 1002, and 1102, of FIGS. 6-11, respectively.

As shown in FIG. 12, the method of flowchart 1200 begins at step 1202. In step 1202, a die body (e.g., die body 210) is provided. For example, a die body comprising an inlet surface, a discharge surface opposite the inlet surface, and an intersecting array of discharge slots is provided. The intersecting array of discharge slots extends into the die body from the discharge surface toward the inlet surface and is formed by side surfaces of a plurality of spaced pins. The pins extend from a pin root to the discharge surface. The die body can be loaded onto a machining platform so that cutting operations can be performed on the die body.

At step 1204, a cutting tool, such as an abrasive wheel, bit of a mill, EDM wire, or other suitable slitting tool, is aligned with at least one of the discharge slots in a center portion of the die body.

At step 1206 the cutting tool is used to remove portions of opposing side surfaces of pins of the die body adjacent to the intended discharge surface of the die body to form the downstream portion. The cutting does not extend axially along the entire length of the pin, such that the downstream portion has a slot width (e.g., width W2) that is greater than the slot width (e.g., width W1) of the upstream portion of the slot that is not cut. In some embodiments, the majority of the discharge slots comprise a swell relief feature (such as a step or taper) between the upstream slot portion having the first width W1 and the downstream slot portion having the second width W2. In some embodiments, the walls defining the downstream slot portion (i.e., the side walls of the pins) are straight and/or parallel to the extrusion direction. In some embodiments, the majority of the discharge slots are tapered between the location having the first width W1 and the location having the second width W2. In an example, the second width W2 is equal to or less than about 0.005 inch (0.13 mm).

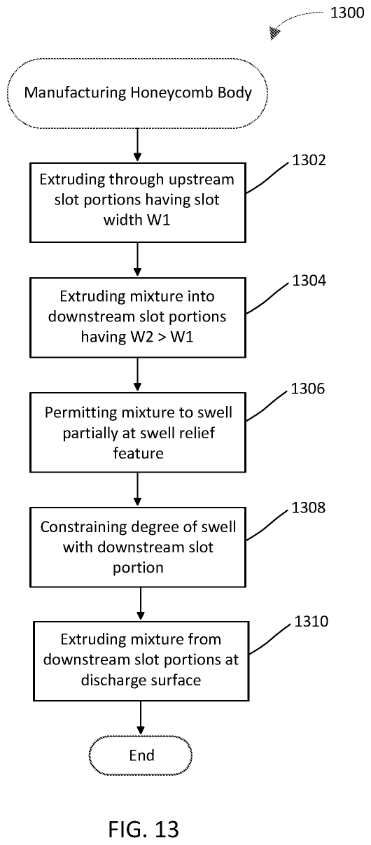

FIG. 13 depicts a flowchart 1300 for manufacturing a honeycomb body (e.g., honeycomb body 330) with an extrusion die (e.g., extrusion die 102, 602, 702, 802, 902, 1002, and 1102). The method of flowchart 1300 can be performed using an extruder, such as the extruder 101 of the system 100. In accordance with the description herein, the generically illustrated extrusion die 102 can take the form of any of extrusion dies 602, 702, 802, 902, 1002, and 1102, and/or a die having combinations of features thereof.

As shown in FIG. 13, the method of flowchart 1300 starts at step 1302 in which a ceramic-forming mixture is extruded through an upstream slot portion of a discharge slot of an extrusion die (e.g., upstream slot portion 618A of discharge slot 618 of extrusion die 602, or the upstream portions of any of discharge slots 718, 818, 918, 1018, 1118, and/or 1119), the upstream slot portion having a first slot width (e.g., first slot width W1). At step 1304, the ceramic-forming mixture is extruded into downstream slot portions (e.g., downstream slot portion 618B) having a slot width that is greater than the slot width of the upstream slot portion (e.g., slot width W2>slot width W1).

At step 1306, the ceramic-forming mixture is permitted to partially swell at a swell relief feature (e.g., step 628, taper 728, steps 828, step 928, step 1028, step 1128, and/or step 1129) positioned between the upstream and downstream portions. As described herein, the second slot width (W2) is greater than the first slot width (W1) but less than an unconstrained swell dimension (e.g., unconstrained swell thickness T1) of the ceramic-forming mixture representative of unconstrained expansion of the ceramic-forming mixture upon exiting the upstream slot portion. Accordingly, at step 1308 the degree of swell of the ceramic-forming mixture is constrained by the downstream slot portion. As described herein, the step 1308 can comprise constraining the ceramic-forming mixture with slot walls (side surfaces of the pins of the extrusion die) of the downstream slot portion that are parallel to the extrusion direction.

At step 1310, the ceramic-forming mixture is extruded from the downstream slot portions at the discharge surface. As described herein, due to permitting swell in step 1306 and constraining swell in step 1308, a constrained thickness (e.g., thickness T2) for the extrudate (e.g., the honeycomb extrudate 104) is achieved, which constrained thickness is less than an unconstrained thickness that would have resulted from unconstrained swell of the ceramic-forming mixture from a slot having the same slot width as the upstream slot portion.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1.-22. (canceled)

23. A honeycomb extrusion die comprising:
a die body comprising:
a plurality of surfaces comprising an inlet surface and a discharge surface opposite the inlet surface, and defining feedholes extending from the inlet surface into the die body; and
a plurality of spaced pins defining an intersecting array of discharge slots extending into the die body from the discharge surface to connections with the feedholes within the die body, the intersecting array of discharge slots being formed by side surfaces of the plurality of spaced pins, wherein the pins extend from a pin root to the discharge surface,
wherein the plurality of spaced pins comprises a first group of pins in a peripheral region adjacent to an outer periphery of the discharge surface and a second group of pins in a central region located inward of the peripheral region and encompassing a center point on the discharge surface;
wherein at least some slots of the second group of discharge slots comprise a first portion comprising a first width W1 adjacent the discharge surface and a second portion comprising a second width W2 that is smaller than width W1, wherein the second portion is at a location between the pin root and the first portion.

24. The honeycomb extrusion die of claim 23 wherein the pins forming the slots of the second group of the discharge slots comprise a step that transitions corresponding slots from the first width W1 to the second width W2.

25. The honeycomb extrusion die of claim 24 wherein the pins forming the slots of the second group of the discharge slots comprise a plurality of steps that transition corresponding slots from the first width W1 to the second width W2.

26. The honeycomb extrusion die of claim 23 wherein the slots of the second group of discharge slots are tapered between the first portion and the second portion.

27. The honeycomb extrusion die of claim 23 wherein the pins have a length of less than 1.00 inch.

28. The honeycomb extrusion die of claim 23 wherein the first width W1 is less than 0.005 inch.

29. The honeycomb extrusion die of claim 23 wherein a percentage difference between the first width W1 and the second width W2 relative to width W1 is in a range between 1% and 10%.

30. The honeycomb extrusion die of claim 23 wherein slots of the first group of discharge slots also comprise the first portion comprising the first width W1 adjacent the discharge surface and the second portion comprising the second width W2 at a location spaced between the pin root and the first portion.

31. The honeycomb extrusion die of claim 23 wherein the peripheral region spans a radial distance from the outer periphery that is at least 20% of a radius of the discharge surface.

32. A honeycomb extrusion die, comprising:
a die body, comprising:
an inlet surface and a discharge surface opposite the inlet surface;
an intersecting array of discharge slots extending into the die body from the discharge surface toward the inlet surface,
the intersecting array of discharge slots being formed by side surfaces of a plurality of pins, wherein the pins extend from a pin root to the discharge surface,
wherein each of a group of pins of the plurality of pins has a first transverse dimension D1 between opposite side surfaces at a first location adjacent the discharge surface and a second transverse dimension D2 between opposite side surfaces at a second location spaced toward the pin root from the first location, wherein the first transverse dimension D1 is less than the second transverse dimension D2, and
wherein the group of pins are spaced from an outer periphery of the discharge surface by a distance that equals at least 20% of a largest transverse dimension of the discharge surface.

33. The honeycomb extrusion die of claim 32 wherein the pins in the group of pins each comprise a step between the first location and the second location.

34. The honeycomb extrusion die of claim 32 wherein the pins in the group of pins each comprise a plurality of steps between the first location and the second location.

35. The honeycomb extrusion die of claim 32 wherein the pins of the group of pins are tapered between the first location and the second location.

36. The honeycomb extrusion die of claim 32 wherein the plurality of pins have a length of less than 1.00 inch.

37. The honeycomb extrusion die of claim 32 wherein the first transverse dimension D1 is in a range between 1% and 10% smaller than the second dimension D2.

38. A honeycomb extrusion die comprising:
a die body, comprising:
an inlet surface and a discharge surface opposite the inlet surface;
an intersecting array of discharge slots extending into the die body from the discharge surface toward the inlet surface,
the intersecting array of discharge slots being formed by side surfaces of a plurality of pins, wherein the pins extend from a pin root to the discharge surface,
wherein a majority of the discharge slots comprise a first portion comprising a first width W1 adjacent the discharge surface and a second portion comprising a second width W2 that is smaller than width W1 at a location spaced between the pin root and the first portion.

39. The honeycomb extrusion die of claim 38 wherein slots of a group of the discharge slots each comprise a third portion having a third width W3 adjacent the discharge surface that is greater than width W1.

40. The honeycomb extrusion die of claim 39 wherein the group of the discharge slots comprise a fourth portion comprising a fourth width W4 spaced between the pin root and the third portion, wherein the fourth width W4 is different than the third width W3.

41. The honeycomb extrusion die of claim 40 wherein the group of discharge slots is disposed toward a peripheral region of the die body from the majority of discharge slots.

42. The honeycomb extrusion die of claim 38 wherein a difference between the first width W1 and the second width W2 is formed by a step.
